(19) United States
(12) Patent Application Publication
(10) Pub. No.: US 2015/0131045 A1
(43) Pub. Date: May 14, 2015

(54) LIQUID CRYSTAL LENS PANEL, DISPLAY DEVICE HAVING THE SAME AND METHOD OF MANUFACTURING THE SAME

(71) Applicant: Samsung Display Co., Ltd., Yongin-City (KR)

(72) Inventor: Jung-Hwan YI, Yongin-si (KR)

(21) Appl. No.: 14/510,304

(22) Filed: Oct. 9, 2014

(30) Foreign Application Priority Data
Nov. 8, 2013 (KR) 10-2013-0135343

(51) Int. Cl. G02F 1/1343; G02F 1/1335

(52) U.S. Cl. CPC G02F 1/134309; G02F 1/133509
USPC 349/143; 445/24

(57) ABSTRACT

A liquid crystal lens panel includes an array substrate, an opposing substrate, and a liquid crystal layer between the array substrate and the opposing substrate. The array substrate includes a first base substrate, a plurality of lens electrodes substantially parallel with one another on the first base substrate, a connection electrode electrically connected to the lens electrodes, a light blocking pattern overlapping the connection electrode and a terminal electrode electrically connected to the connection electrode. The opposing substrate includes a second base substrate which faces the array substrate and a lens common electrode which is on the second base substrate.

This application claims priority to Korean Patent Application No. 10-2013-0135343, filed on Nov. 8, 2013, and all the benefits accruing therefrom under 35 U.S.C. §119, the contents of which in its entirety is herein incorporated by reference.

### BACKGROUND

1. Field

Exemplary embodiments of the invention relate to a liquid crystal lens panel, a display device having the same and a method of manufacturing the same. More particularly, exemplary embodiments of the invention relate to a liquid crystal lens panel, a display device having the same and a method of manufacturing the same, capable of improving display quality.

2. Description of the Related Art

As demand for three-dimensional (“3D”) stereoscopic images increases in consumer markets like the game market, the movie market, and so on, display devices configured to display 3D stereoscopic images have been developed. For example, conventional 3D display devices are configured to present two-dimensional (“2D”) images different from each other to respective eyes of an observer, such that the 3D stereoscopic image can be autonomically perceived by the observer. For example, the observer may view a pair of 2D images through respective left and right eyes, and then the 2D images may be mixed in the observer's brain to be recognized as a 3D stereoscopic image.

Typically, 3D stereoscopic display devices are classified into a glasses type display device and a no-glasses type display device. The glasses type display device utilizes polarized light to respectively radiate 2D images to respective left and right eyes of viewers, whereas the no-glasses type display device utilizes a lenticular lens to separate and, thereby, direct the presentation of left-eye images and right-eye images to corresponding eyes of an observer.

For instance, display devices of the glasses type include an active polarizing panel in which a left-eye image and a right-eye image are displayed, such that the display panel changes the polarization of light associated with each image so that the observer, via polarized light glasses, is able to perceive the left-eye image via their left-eye and the right-eye image via their right-eye. Display devices of the no-glasses type include a lenticular lens in which a left-eye image and a right-eye image displayed on sub-pixels of a display panel are diffracted into a plurality of views, so that an observer may view the left-eye image via their left-eye and the right-eye image via their right-eye. For example, a liquid crystal lens panel may be used as the lenticular lens. The liquid crystal lens panel may include a liquid crystal layer interposed between an upper electrode and a lower electrode.

### SUMMARY

A lower electrode of the liquid crystal lens panel may reflect external light at a border region of the liquid crystal lens panel, thereby interrupting three-dimensional (“3D”) image recognition of an observer. Also, if the liquid crystal lens panel includes an additional light blocking pattern at the border region on an upper substrate of the liquid crystal lens panel, a manufacturing cost of the liquid crystal lens panel may increase due to an additional mask to form the light blocking pattern.

One or more exemplary embodiment of the invention provides a liquid crystal lens panel capable of reducing reflection of external light and of decreasing manufacturing cost thereof.

Also, another exemplary embodiment of the invention provides a display device having the liquid crystal lens panel.

Furthermore, still another exemplary embodiment of the invention provides a method of manufacturing the liquid crystal lens panel.

In an exemplary embodiment of a liquid crystal lens panel according to the invention, the liquid crystal lens panel includes an array substrate, an opposing substrate, and a liquid crystal layer between the array substrate and the opposing substrate. The array substrate includes a first base substrate, a plurality of lens electrodes substantially parallel with one another on the first base substrate, a connection electrode electrically connected to the lens electrodes, a light blocking pattern overlapping the connection electrode and a terminal electrode electrically connected to the connection electrode. The opposing substrate includes a second base substrate which faces the array substrate and a lens common electrode which is on the second base substrate.

In an exemplary embodiment, the lens electrodes and the terminal electrode may be in a same layer.

In an exemplary embodiment, the connection electrode may be between the light blocking pattern and the first base substrate.

In an exemplary embodiment, the liquid crystal lens panel may further include contact holes defined in the light blocking pattern, the light blocking pattern may be between the lens electrodes and the connection electrode and between the terminal electrode and the connection electrode, and the lens electrodes and the terminal electrode may be electrically connected to the connection electrode through the contact holes defined in the light blocking pattern.

In an exemplary embodiment, the lens electrodes and the terminal electrode may be between the light blocking pattern and the first base substrate.

In an exemplary embodiment, the liquid crystal lens panel may further include contact holes defined in the light blocking pattern, the light blocking pattern may be between the connection electrode and the lens electrodes and between the connection electrode and the terminal electrode, and the connection electrode may be electrically connected to the lens electrodes and the terminal electrode, through the contact holes defined in the light blocking pattern.

In an exemplary embodiment, the liquid crystal lens panel may further include a column spacer partially overlapping a lens electrode among the lens electrodes.

In an exemplary embodiment, the light blocking pattern may extend in a first direction in which the connection electrode extends.

In an exemplary embodiment, the liquid crystal lens panel may further include a sealing member crossing the terminal electrode to maintain a cell gap between the array substrate and the opposing substrate.

In an exemplary embodiment, the light blocking pattern may include an align mark portion adjacent to the terminal electrode. The align mark portion may include a first extending portion crossing the first direction and extending in a second direction in which the terminal electrode extends toward an outside of the sealing member and a second extending portion extending from a distal end of the first extending portion and in a third direction crossing the second direction.

In an exemplary embodiment of a display device according to the invention, the display device includes a liquid crystal lens panel, a liquid crystal display panel configured to emit multi-viewpoint images toward the liquid crystal lens panel by using a plurality of pixel electrodes and a pixel common electrode, and a light source part configured to generate light toward the liquid crystal display panel. The liquid crystal lens panel includes an array substrate, an opposing substrate facing the array substrate and a liquid crystal layer between the array substrate and the opposing substrate. The array substrate include a plurality of lens electrodes substantially parallel with one another, a connection electrode electrically connected to the lens electrodes, a light blocking pattern overlapping the connection electrode and a terminal electrode electrically connected to the connection electrode. The opposing substrate includes a lens common electrode.

In an exemplary embodiment, the display device may further include a retardation film between the liquid crystal lens panel and the liquid crystal display panel.

In an exemplary embodiment, the display device may further include an active driving part configured to drive the liquid crystal lens panel. The active driving part may be configured to apply voltages to the lens electrodes and the lens common electrode to form a plurality of liquid crystal lens units.

In an exemplary embodiment, the liquid crystal lens units may be configured to refract the multi-viewpoint images emitted by liquid crystal display panel toward a plurality of viewpoint areas with respect to the display device.

In an exemplary embodiment, the lens electrodes and the terminal electrode may be in a same layer and may include a transparent conductive material.

In an exemplary embodiment, the array substrate may further include a first base substrate and contact holes defined in the light blocking pattern. The connection electrode may be between the light blocking pattern and the first base substrate, the light blocking pattern may be between the lens electrodes and the connection electrode and between the terminal electrode and the connection electrode, and the lens electrodes and the terminal electrode may be electrically connected to the connection electrode through the contact holes defined in the light blocking pattern.

In an exemplary embodiment, the array substrate may further include a first base substrate and contact holes defined in the light blocking pattern. The lens electrodes and the terminal electrode, may be between the light blocking pattern and the first base substrate, the light blocking pattern may be between the connection electrode and the lens electrodes and between the connection electrode and the terminal electrode, and the connection electrode may be electrically connected to the lens electrodes and the terminal electrode, through the contact holes defined in the light blocking pattern.

In an exemplary embodiment of a method of manufacturing a liquid crystal lens panel according to the invention, a light blocking metal layer is formed on a base substrate. The light blocking metal layer is patterned to form a connection electrode. A light blocking layer covering the connection electrode is formed on the base substrate. The light blocking layer is patterned to form a plurality of contact holes partially exposing the connection electrode. A transparent conductive layer is formed on the base substrate and in the contact holes. The transparent conductive layer is patterned to form a terminal electrode and a plurality of lens electrodes. The terminal electrode is electrically connected to the connection electrode through a first contact hole among the plurality of the contact holes.

The lens electrodes are electrically connected to the connection electrode through second contact holes among the plurality of the contact holes. The lens electrodes are substantially parallel with one another.

In an exemplary embodiment, a plurality of column spacers may be formed on the base substrate including the lens electrodes thereon. The column spacers may be spaced apart from one another.

In another exemplary embodiment of a method of manufacturing a liquid crystal lens panel according to the invention, a transparent conductive layer is formed on a base substrate. The transparent conductive layer is patterned to form a terminal electrode and a plurality of lens electrodes. The lens electrodes are substantially parallel with one another. A light blocking layer which covers the terminal electrode and the lens electrodes is formed on the base substrate. The light blocking layer is patterned to form a plurality of contact holes partially exposing the terminal electrode and the lens electrodes. A light blocking metal layer is formed on the base substrate and in the contact holes. The light blocking metal layer is patterned to form a connection electrode. The connection electrode is electrically connected to the terminal electrode through a first contact hole of the contact holes and electrically connected to the lens electrodes through second contact holes of the contact holes.

According to one or more exemplary embodiment of the liquid crystal lens panel, the display device having the same and the method of manufacturing the same, the light blocking pattern may cover the connection electrodes, thereby reducing reflection of external light which is recognizable at a border region of a display area of the liquid crystal lens panel.

Also, in one or more exemplary embodiment of the method of manufacturing the liquid crystal lens panel, the light blocking pattern may be directly formed on the array substrate including the connection electrodes thereon, thereby reducing manufacturing cost of the liquid crystal lens panel without an additional mask to form the light blocking pattern on the opposing substrate.

Furthermore, in one or more exemplary embodiment of the liquid crystal lens panel, the light blocking pattern may further include an align mark portion which extends to an outside of the display area to clearly indicate a position of terminal electrodes, thereby allowing relative easy connection of an external terminal power source to the terminal electrodes which are connected to the connection electrodes.

### BRIEF DESCRIPTION OF THE DRAWINGS

The above and other features and advantages of the invention will become more apparent by describing in detailed exemplary embodiments thereof with reference to the accompanying drawings, in which:

FIG. 1 is an exploded perspective view illustrating an exemplary embodiment of a display device according to the invention;

FIG. 2 is an exploded perspective view illustrating an exemplary embodiment of a lens panel assembly of the display device of FIG. 1;

FIG. 3 is a plan view illustrating an exemplary embodiment of a liquid crystal lens panel of the lens panel assembly of FIG. 2;

FIG. 4 is an enlarged plan view illustrating portion “A” of FIG. 3;

FIG. 5 is a cross-sectional view taken along line I-I′ of FIG. 4;

FIGS. 6A to 6G are cross-sectional views illustrating an exemplary embodiment of a manufacturing method of an array substrate of the liquid crystal lens panel of FIG. 5;

FIG. 7 is an exploded perspective view illustrating another exemplary embodiment of a lens panel assembly according to the invention;

FIG. 8 is a cross-sectional view illustrating an exemplary embodiment of a liquid crystal lens panel of the lens panel assembly of FIG. 7; and

FIGS. 9A to 9G are cross-sectional views illustrating an exemplary embodiment of a manufacturing method of an array substrate of the liquid crystal lens panel of FIG. 8.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “under” relative to other elements or features would then be oriented “above” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in further detail with reference to the accompanying drawings.

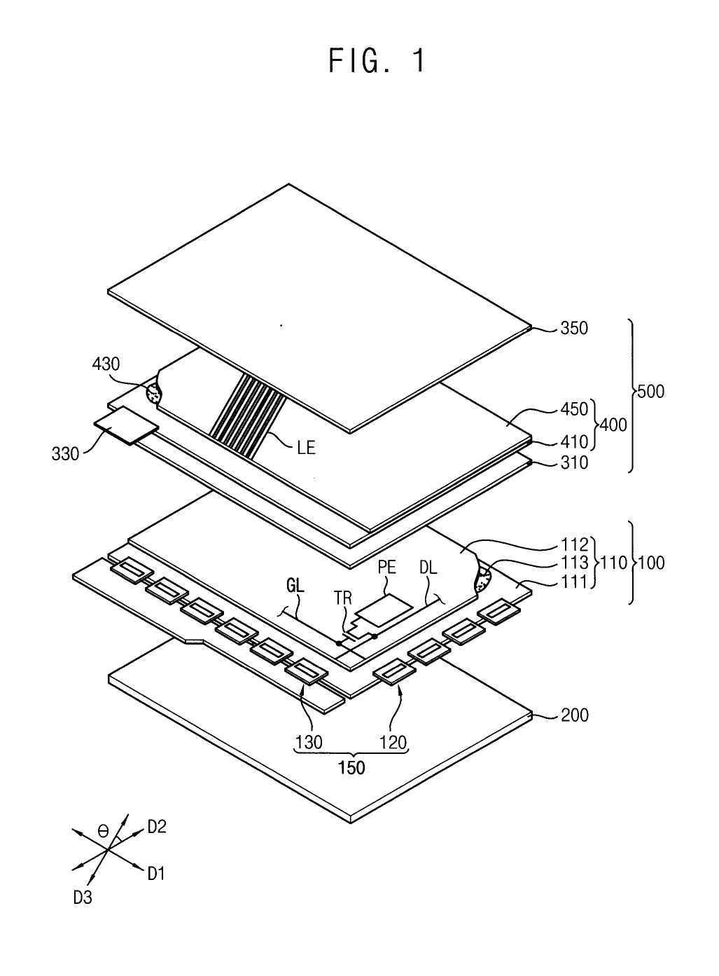

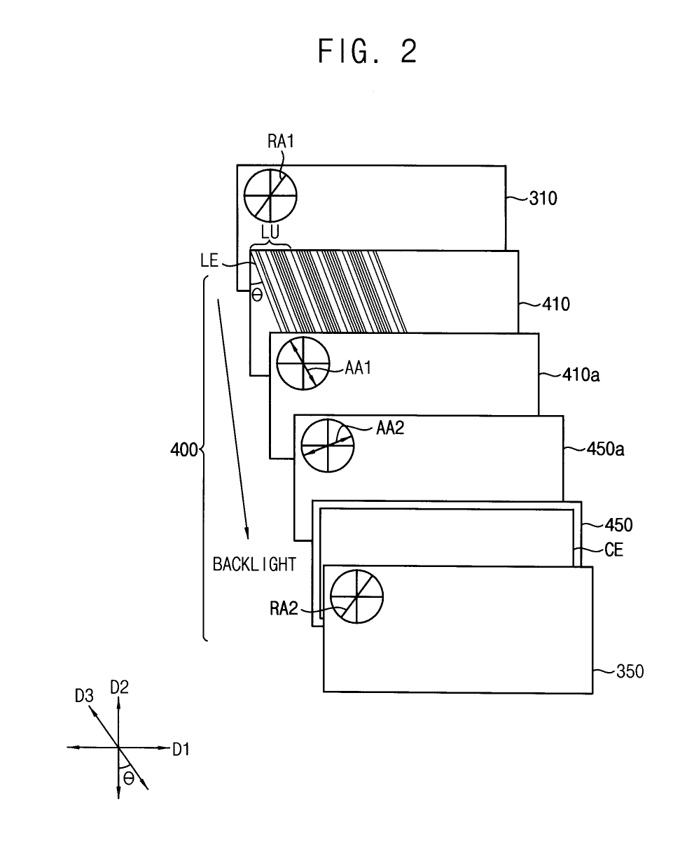

FIG. 1 is an exploded perspective view illustrating an exemplary embodiment of a display device according to the invention. FIG. 2 is an exploded perspective view illustrating a lens panel assembly of FIG. 1.

Referring to FIG. 1 and FIG. 2, a display device may include a display panel assembly 100, a light source part 200 and a lens panel assembly 500.

The display panel assembly 100 may include a liquid crystal display panel 110, and an image driving part 150 configured to drive the liquid crystal display panel 110.

The liquid crystal display panel 110 may include a first substrate 111, a second substrate 112 and a first liquid crystal layer 113.

The first substrate 111 may include a plurality of gate lines GL, a plurality of data lines DL, a plurality of switching elements TR and a plurality of pixel electrodes PE. The gate lines GL may extend in a first direction D1, respectively. The gate lines GL may be arranged in a second direction D2 crossing the first direction D1. The data lines DL may extend in the second direction D2, respectively. The data lines DL may be arranged in the first direction D1. The switching elements TR may be electrically connected to the gate lines GL and the data lines DL. The pixel electrodes PE may be electrically connected to the switching elements TR. The pixel electrodes PE may be disposed at pixel areas of the display device.

The second substrate 112 may face the first substrate 111. The first liquid crystal layer 113 may be disposed between the first substrate 111 and the second substrate 112. The second substrate 112 may include color filters (not shown) overlapping the pixel areas. Alternatively, the color filters may be disposed on the first substrate 111. The second substrate 112 may include a pixel common electrode (not shown) which is configured to form vertical electric fields with the pixel electrodes PE. Alternatively, the pixel common electrode may overlap the pixel electrodes PE on the first substrate 111 and may be configured to form horizontal electric fields with the pixel electrodes PE. A slit pattern may be defined in the pixel electrodes PE and/or the pixel common electrode, but the invention is not limited thereto.

The image driving part 150 may be configured to drive the liquid crystal display panel 110 such that multi-viewpoint images are displayed on the liquid crystal display panel 110.

The image driving part 150 may include a gate driving part 120 and a data driving part 130. The gate driving part 120 may be configured to provide the gate lines with gate signals. As illustrated in FIG. 1, the gate driving part 120 may be disposed on (e.g., mounted on) the liquid crystal display panel 110, such as, in the form of, a tape carrier package (“TCP”), or may be directly disposed on (e.g., formed on) the first substrate 111. In an exemplary embodiment of a manufacturing method of the display device, the gate driving part 120 may be formed via one or more of the processes utilized in association with forming the switching elements TR.

The data driving part 130 may output data signals to the data lines DL.

In the illustrated exemplary embodiment, the liquid crystal display panel 110 may display n-viewpoint images where “n” is a natural number greater than one. One frame image may include a plurality of viewpoint images.

The light source part 200 may be configured to generate light and direct the light toward the liquid crystal display panel 110. The light source part 200 may be or include a direct-illumination type and/or an edge-illumination type light source. The direct-illumination type light source may include at least one light source disposed under a display area of the liquid crystal display panel 110, in which the pixel electrodes PE are arranged. The edge-illumination type light source may include a light guide plate disposed under the display area of the liquid crystal display panel 110, as well as include at least one light source disposed on an edge portion of the light guide plate.

The lens panel assembly 500 may include a liquid crystal lens panel 400, a first retardation film 310, a second retardation film 350 and an active driving part 330.

The liquid crystal lens panel 400 may include an array substrate 410, an opposing substrate 450 and a second liquid crystal layer 430.

The array substrate 410 may include a plurality of lens electrodes LE and a first alignment layer 410a having a first alignment direction AA1. The lens electrodes LE may be grouped to form a plurality of electrode groups LU which corresponds to or defines a plurality of liquid crystal lens units. Each electrode group LU may include a plurality of lens electrodes among the lens electrodes LE. The lens electrodes LE may extend in a third direction D3 tilted from the second direction D2 respectively. The axis of lenses of the liquid crystal lens units may be tilted to an inclination angle θ from the second direction D2.

The opposing substrate 450 may face the array substrate 410. The opposing substrate 450 may have a lens common electrode CE and a second alignment layer 450a having a second alignment direction AA2 tilted from the first alignment direction AA1. The lens common electrode CE may have a flat plane shape without a silt pattern defined therein.

The second liquid crystal layer 430 may be disposed between the array substrate 410 and the opposing substrate 450 and, thereby, between the first alignment layer 410a and the second alignment layer 450a. Liquid crystal molecules of the second liquid crystal layer 430 may be aligned exhibiting a twist angle from the first alignment direction AA1 and the second alignment direction AA2.

The first retardation film 310 may be disposed between the liquid crystal lens panel 400 and the liquid crystal display panel 110. The first retardation film 310 may delay a phase of light transmitted from the liquid crystal display panel 110 by a first slow axis RA1.

The second retardation film 350 may be adjacent to the opposing substrate 450 of the liquid crystal lens panel 400. The second retardation film 350 may delay a phase of light transmitted from the liquid crystal lens panel 400 by a second slow axis RA2 which is parallel with the first slow axis RA1.

The active driving part 330 may be configured to provide the liquid crystal lens panel 400 with voltages. The active driving part 330 may apply voltages having a plurality of levels to the lens electrodes LE, thereby implementing liquid crystal lenses. The electrode groups LU may be configured to define the liquid crystal lens units to form the liquid crystal lenses.

In an exemplary embodiment, for example, a common voltage may be applied to the lens common electrode CE on the opposing substrate 450. In addition, a plurality of voltages may be applied to the lens electrodes LE on the array substrate 410, thereby forming a Fresnel lens having a desired distribution of refraction. Where a Fresnal lens is formed, the liquid crystal display panel 110 may display the n-viewpoint images during a frame.

A first polarized light of the n-viewpoint images having a first polarization axis transmitted from the liquid crystal display panel 110 may be adjusted to a second polarized light having a second polarization axis by the first retardation film 310 to enter the liquid crystal lens panel 400.

The liquid crystal lens panel 400 defining the liquid crystal lenses may change the second polarized light having the second polarization axis to a plurality of polarized lights having a plurality of polarization axes, thereby refracting the n-viewpoint images toward n-viewpoint areas. The refracted n-viewpoint images may be further adjusted by the second retardation film 350 to emit outward from the lens panel assembly 400. In this manner, an observer may view a three-dimensional image without any glasses.

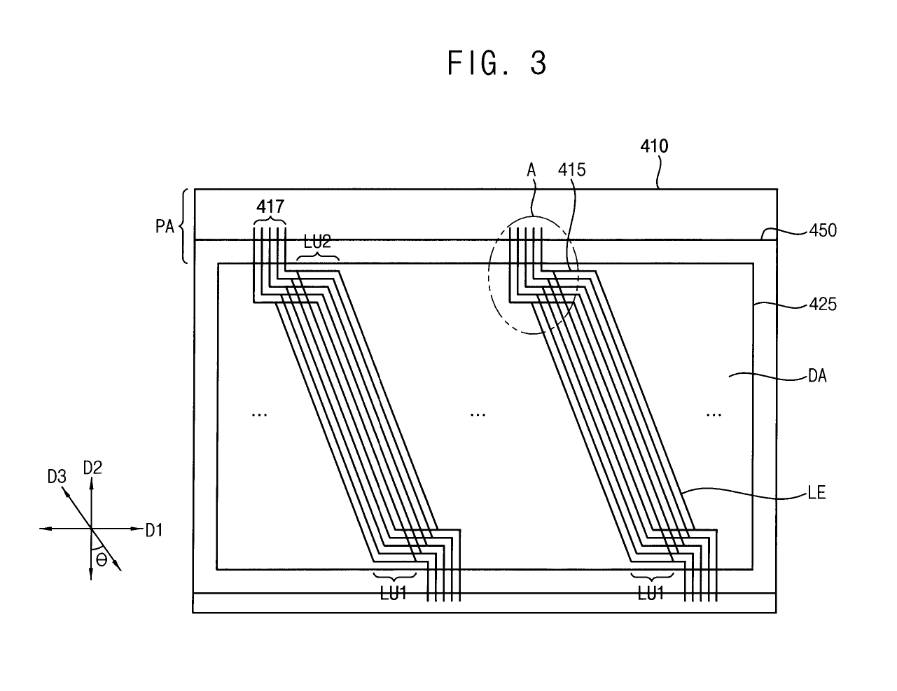

FIG. 3 is a plan view illustrating an exemplary embodiment of a liquid crystal lens panel of the lens panel assembly of FIG. 2.

Referring to FIG. 3, the liquid crystal lens panel 400 may include the array substrate 410 and the opposing substrate 450. The second liquid crystal layer 430 may be disposed between the array substrate 410 and the opposing substrate 450. The second liquid crystal layer 430 may be sealed between the array substrate 410 and the opposing substrate 450 by a seal line 425. An internal area of the seal line 425 may overlap the display area DA of the liquid crystal lens panel 400 through which the n-viewpoint images are emitted. The seal line 425 may otherwise be referred to a sealing member which is configured to seal the second liquid crystal layer 430 between the array substrate 410 and the opposing substrate 450.

The plurality of lens electrodes LE may extend in the third direction D3 in the display area DA. The lens electrodes LE may be grouped to form the plurality of electrode groups LU1 and LU2, each including a plurality of lens electrodes among the lens electrodes LE. Each of the lens electrodes LE may be electrically connected to a terminal part 417. An external power source (not shown) may apply a desired voltage to the lens electrodes LE through the terminal part 417. A connection part 415 may electrically connect the lens electrodes LE and the terminal part 417, respectively. An external area of the seal line 425 may overlap a peripheral area PA of the liquid crystal lens panel 400 adjacent to the display area DA. A distal end portion of the terminal part 417 may be disposed on the peripheral area PA.

In the illustrated exemplary embodiment, the connection part 415 may be connected to one or more of the plurality of electrode groups LU. In an exemplary embodiment, for example, the connection part 415 may be connected to two electrode groups LU1 and LU2. In addition, each of the electrode groups LU1 and LU2 may include one or more of the lens electrodes LE. In the illustrated exemplary embodiment, for example, the electrode groups LU1 and LU2 may include five lens electrodes LE. Although two electrode groups LU1 and LU2 are connected to the same connection part 415 and each of the electrode groups LU1 and LU2 includes five lens electrodes LE in FIG. 3, the number of electrode groups LU connected to the same connection part 415 and the number of lens electrodes LE of each of the electrode groups LU are not limited thereto.

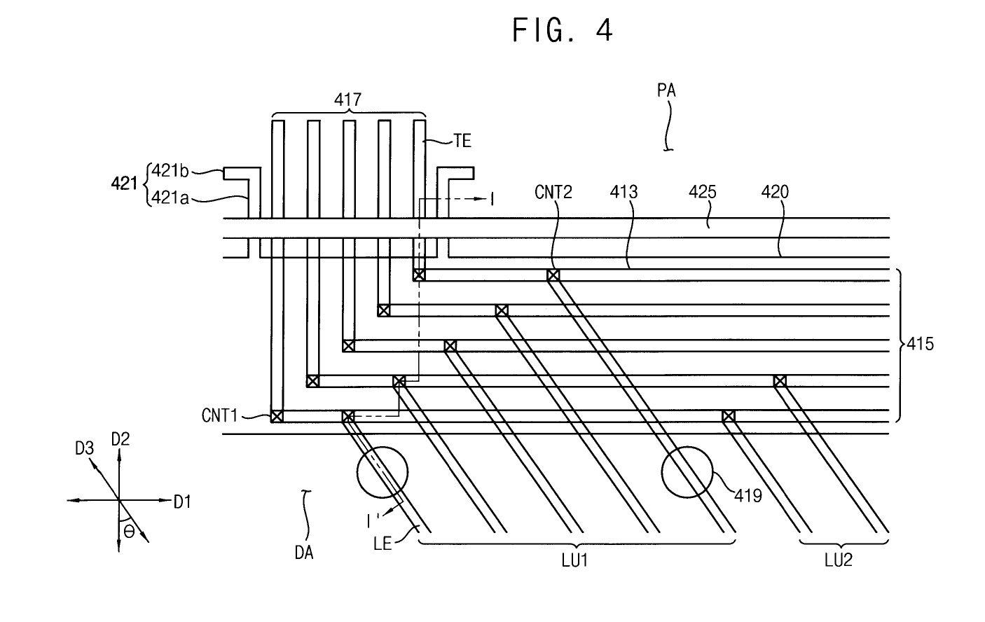

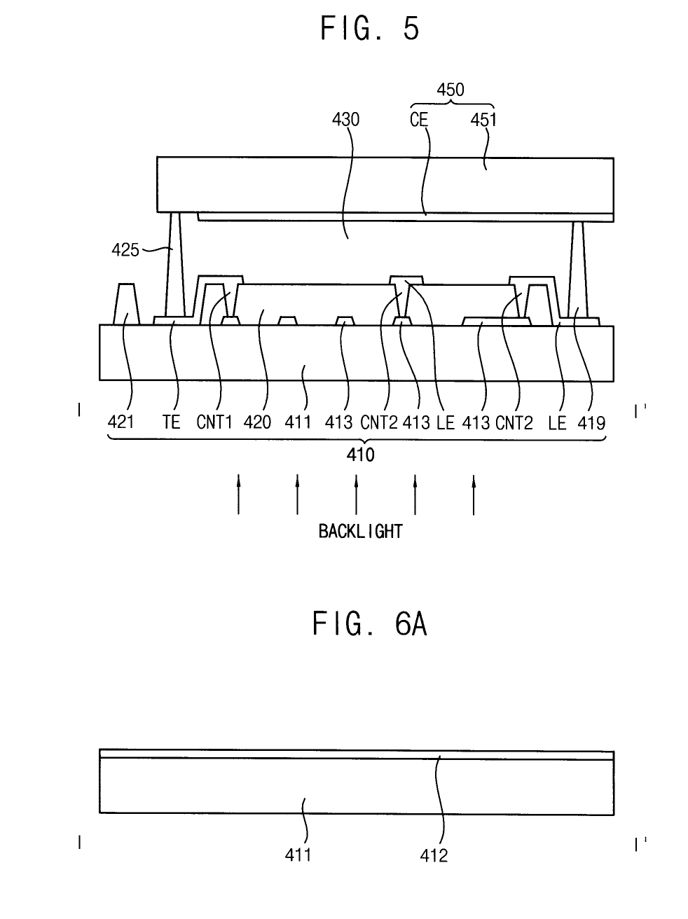

FIG. 4 is an enlarged plan view illustrating portion “A” of FIG. 3. FIG. 5 is a cross-sectional view taken along line I-I′ of FIG. 4.

Referring to FIG. 4 and FIG. 5, the liquid crystal lens panel 400 may include the array substrate 410, the opposing substrate 450 and the second liquid crystal layer 430 therebetween. The second liquid crystal layer 430 may be sealed by the seal line 425.

The array substrate 410 may include a first base substrate 411, a plurality of connection electrodes 413, the plurality of lens electrodes LE, a plurality of terminal electrodes TE and a light blocking pattern 420. The plurality of connection electrodes 413 may collectively define the connection part 415, and may be considered a lower electrode of the liquid crystal lens panel 400. Similarly, the plurality of terminal electrodes TE may collectively define the terminal part 417. The array substrate 410 may further include a plurality of column spacers 419. The column spacers 419 may maintain a cell gap between the array substrate 410 and the opposing substrate 450. The array substrate 410 may further include the first alignment layer 410a (illustrated in FIG. 2) covering the lens electrodes LE and the terminal electrodes TE.

The first base substrate 411 may include a transparent insulation material. In an exemplary embodiment, for example, the first base substrate 411 may include a glass, a quartz, a plastic, a polyethylene terephthalate resin, a polyethylene resin, a polycarbonate resin, etc.

The connection electrodes 413 may be disposed on the first base substrate 411. The connection electrodes 413 may extend in the first direction D1 respectively. The connection electrodes 413 may be arranged in the second direction D2. The connection electrodes 413 may include a metallic material which reflects light. In an exemplary embodiment, for example, the connection electrodes 413 may include aluminum (Al), titanium (Ti), copper (Cu), molybdenum (Mo), tantalum (Ta), tungsten (W), neodymium (Nd), chromium (Cr), silver (Ag), etc.

The light blocking pattern 420 may be disposed on the first base substrate 411 and the connection electrodes 413. The light blocking pattern 420 may cover the connection electrodes 413. The light blocking pattern 420 may extend in the first direction D1 to cover the connection electrodes 413. The light blocking pattern 420 may include an organic and/or inorganic material which absorbs light. In an exemplary embodiment, for example, the light blocking pattern 420 may include carbon black (“CB”), titan black (“TiBK”), chromium (Cr), chromium oxide, chromium nitride, etc.

The light blocking pattern 420 may directly cover the connection electrodes 413, thereby reducing reflection of external light due to the connection electrodes 413 at a border region of the display area DA. With reference to the traveling direction of the backlight (indicated by up arrows in FIG. 5), the light blocking pattern 420 follows the connecting electrodes 413, such that the connection electrodes 413 are between the light blocking pattern 420 and the base substrate 411.

The light blocking pattern 420 may further include at least one or more of an align mark portion 421 disposed at the peripheral area PA. The align mark portion 421 may at least partially extend in the second direction D2, such as from a main portion of the light blocking pattern 420. Positions of the terminal electrodes TE may be easily recognized due to the align mark portion 421. As in the illustrated exemplary embodiment, for example, the light blocking pattern 420 may include a pair of align mark portions 421 respectively adjacent to opposing sides of the terminal part 417. The align mark portions 421 may include a pair of first extending portions 421a which extend in the second direction D2. The align mark portions 421 may further include a pair of second extending portions 421b which extend in the first direction D1. The second extending portions 421b may be connected to the first extending portions 421a, respectively. As in the illustrated exemplary embodiment, for example, the second extending portions 42 lb may be connected to distal end portions of the first extending portions 421a. The second extending portions 421b may extend in the first direction D1 away from and towards an outside of the terminal part 417. As in the illustrated exemplary embodiment, for example, the first extending portions 421a may be substantially perpendicular to the second extending portions respectively.

The terminal electrodes TE may be disposed on the first base substrate 411 and the light blocking pattern 420. The terminal electrodes TE may extend in the second direction D2. The terminal electrodes TE may be arranged in the first direction D1. A first end portion of each of the terminal electrodes TE may be disposed at the peripheral area PA. A second end portion of each of the terminal electrodes TE opposite to the first end portion may be disposed at the display area DA. The terminal electrodes TE may be electrically connected to the connection electrodes 413 through first contact holes CNT1 defined in the light blocking pattern 420 respectively. As in the illustrated exemplary embodiment, for example, the second end portion of the terminal electrode TE may contact the connection electrode 413 through the first contact hole CNT1. The terminal electrodes TE may include a transparent conductive material. In an exemplary embodiment, for example, the terminal electrodes TE may include indium zinc oxide (“IZO”), indium tin oxide (“ITO”), etc.

The lens electrodes LE may be disposed on the first base substrate 411 and the light blocking pattern 420. The lens electrodes LE may extend in the third direction D3, respectively. The lens electrodes LE may be arranged in the first direction D1. A first end portion of each of the lens electrodes LE may be electrically connected to the connection electrodes 413 through second contact holes CNT2 defined in the light blocking pattern 420. The lens electrodes LE may be spaced apart from one another by a desired interval in the first direction D1. The interval between the lens electrodes LE may be different from one another. In an exemplary embodiment, for example, the lens electrodes LE may be spaced apart from one another to form a Fresnel lens having a desired distribution of refraction by a first electrode group LU1 and a second electrode group LU2. The lens electrodes LE may include a transparent conductive material. In an exemplary embodiment, for example, the lens electrodes LE may include IZO, ITO, etc. The lens electrodes LE may be in and/or on a same layer as the terminal electrodes TE, and may be considered in a same single layer of the array substrate 410.

The column spacers 419 may be disposed on the first base substrate 411 and the lens electrodes LE. The column spacers 419 may be spaced apart from one another in the display area DA. As in the illustrated exemplary embodiment, for example, one of the column spacers 419 may be disposed overlapping the lens electrodes LE. The column spacers 419 may include the same material as the light blocking pattern 420.

The opposing substrate 450 may include a second base substrate 451 and the lens common electrode CE. The opposing substrate 450 may further include the second alignment layer 450a (illustrated in FIG. 2) covering the lens common electrode CE.

The second base substrate 451 may include a transparent insulation material. In an exemplary embodiment, for example, the second base substrate 451 may include a glass, a quartz, a plastic, a polyethylene terephthalate resin, a polyethylene resin, a polycarbonate resin, etc.

The lens common electrode CE may be disposed on the second base substrate 451. The lens common electrode CE may have a flat-plane shape without a slit pattern defined therein. The lens common electrode CE may include a transparent conductive material. In an exemplary embodiment, for example, the lens common electrode CE may include IZO, ITO, etc.

The seal line 425 may be disposed on the array substrate 410 or the opposing substrate 450. As in the illustrated exemplary embodiment, for example, the seal line 425 may extend in a direction at least partially crossing the terminal electrodes TE, on the array substrate 410.

As mentioned above, according to one or more exemplary embodiment of a liquid crystal lens panel and a display device having the same, the light blocking pattern 420 may cover the connection electrodes 413, thereby reducing reflection of external light due to the connection electrodes 413 at the border region of the display area DA.

Also, the light blocking pattern 420 may further include the align mark portion 421 which extends toward an outside of the display area DA to clearly indicate a position of the terminal electrodes TE, thereby allowing relatively easy connection of the terminal electrodes TE to an external power source (not shown).

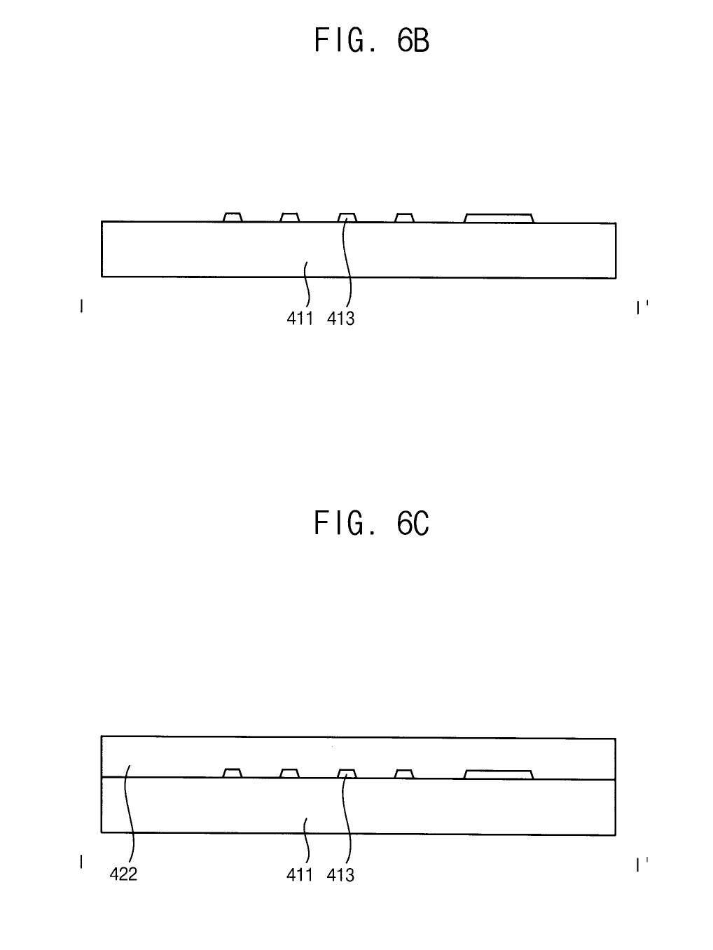

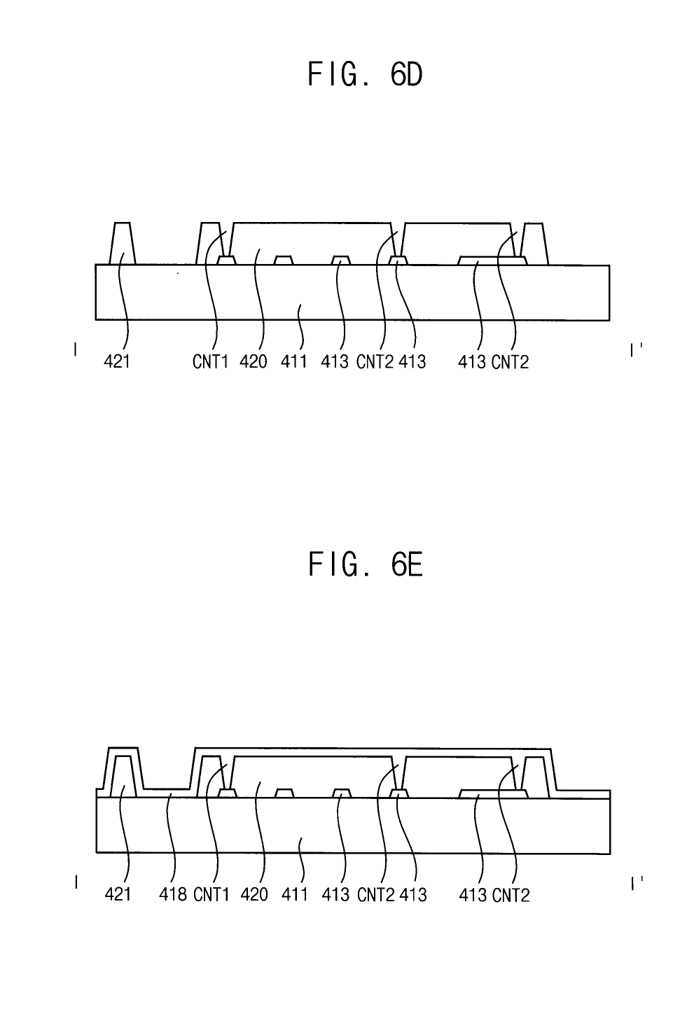

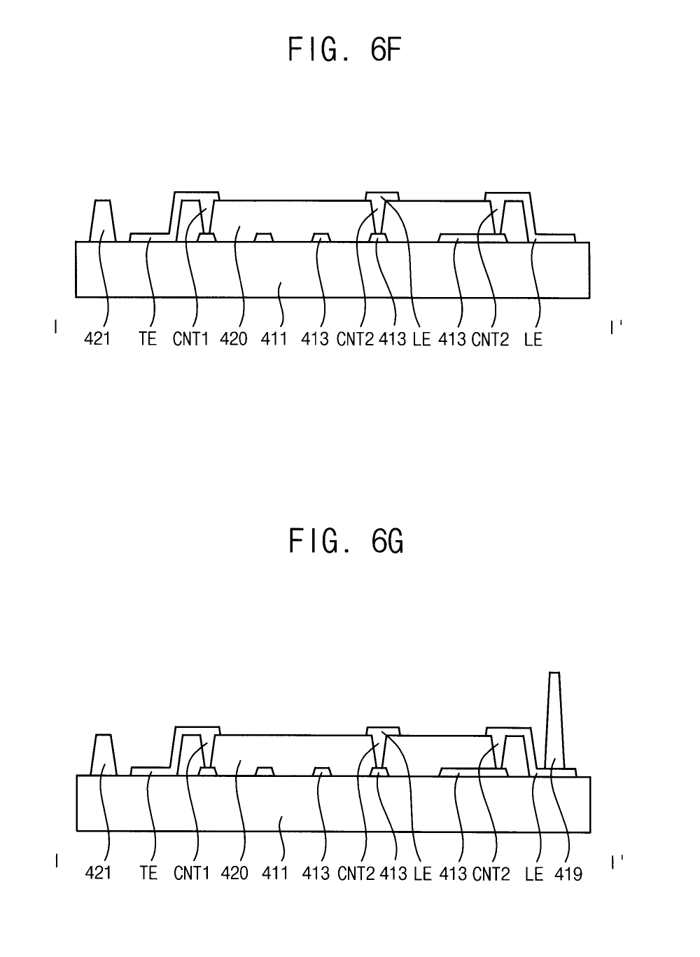

FIGS. 6A to 6G are cross-sectional views illustrating an exemplary embodiment of a manufacturing method of an array substrate of the liquid crystal lens panel of FIG. 5.

Referring to FIG. 6A, a connection electrode layer 412 may be formed on a first base substrate 411. The first base substrate 411 may include a transparent insulation material. The connection electrode layer 412 may include a metallic material which reflects light. In an exemplary embodiment, for example, the connection electrode layer 412 may include aluminum (Al), titanium (Ti), copper (Cu), molybdenum (Mo), tantalum (Ta), tungsten (W), neodymium (Nd), chromium (Cr), silver (Ag), etc.

Referring to FIG. 6B, the connection electrode layer 412 may be patterned such as by using a first mask to form a plurality of connection electrodes 413 on the first base substrate 411. The connection electrodes 413 may extend in a first direction D1. The connection electrodes 413 may be arranged in a second direction D2 crossing the first direction D1.

Referring to FIG. 6C, a light blocking layer 422 may be formed on the first base substrate 411 including the connection electrodes 413 thereon. The light blocking layer 422 may entirely cover the connection electrodes 413 on the base substrate 411. The light blocking layer 422 may include an organic and/or inorganic material. In an exemplary embodiment, for example, the light blocking layer 422 may include CB, TiBK, chromium (Cr), chromium oxide, chromium nitride, etc.

Referring to FIG. 6D, the light blocking layer 422 may be patterned such as by using a second mask to form a light blocking pattern 420 on the first base substrate 411. The light blocking pattern 420 may extend in the first direction D1 to cover the connection electrodes 413. The light blocking pattern 420 may further include an align mark portion 421 disposed at a peripheral area PA. A first contact hole CNT1 and a second contact hole CNT2 may be defined in the patterned light blocking layer. The first contact hole CNT1 and the second contact hole CNT2 may partially expose the connection electrodes 413.

Referring to FIG. 6E, a transparent conductive layer 418 may be formed on the first base substrate 411 including the light blocking pattern 420 thereon. The transparent conductive layer 418 may include, for example, IZO, ITO, etc.

Referring to FIG. 6F, the transparent conductive layer 418 may be patterned such as by using a third mask to form a plurality of terminal electrodes TE and a plurality of lens electrodes LE on the first base substrate 411. A first end portion of each of the terminal electrodes TE may be electrically connected to the connection electrodes 413 through the first contact hole CNT1. A first end portion of each of the lens electrodes LE may be electrically connected to the connection electrodes 413 through the second contact hole CNT2. The terminal electrodes TE may extend in the second direction D2 respectively. The terminal electrodes TE may be arranged in the first direction D1. The lens electrodes LE may extend in a third direction D3 tilted to a desired angle θ from the second direction D2 respectively. The lens electrodes LE may be arranged in the first direction D1. The lens electrodes LE may be spaced apart from one another by an interval in the first direction D1. The interval between the lens electrodes LE may be different from one another. The lens electrodes LE and the terminal electrodes TE are in a same single layer of the array substrate 410 and include the same material.

Referring to FIG. 6G, an insulation layer may be formed on the first base substrate 411 including the terminal electrodes TE and the lens electrodes LE thereon. The insulation layer may be patterned such as by using a fourth mask to form a plurality of column spacers 419. The column spacers 419 may be spaced apart from one another by a desired interval. As in the illustrated exemplary embodiment, for example, one of the column spacers 419 may be formed on the lens electrodes LE.

As mentioned above, according to the exemplary embodiment of the method of manufacturing the liquid crystal lens panel, the light blocking pattern 420 may be directly formed on the connection electrodes 413, thereby reducing manufacturing cost of the liquid crystal lens panel without an additional mask to form the light blocking pattern.

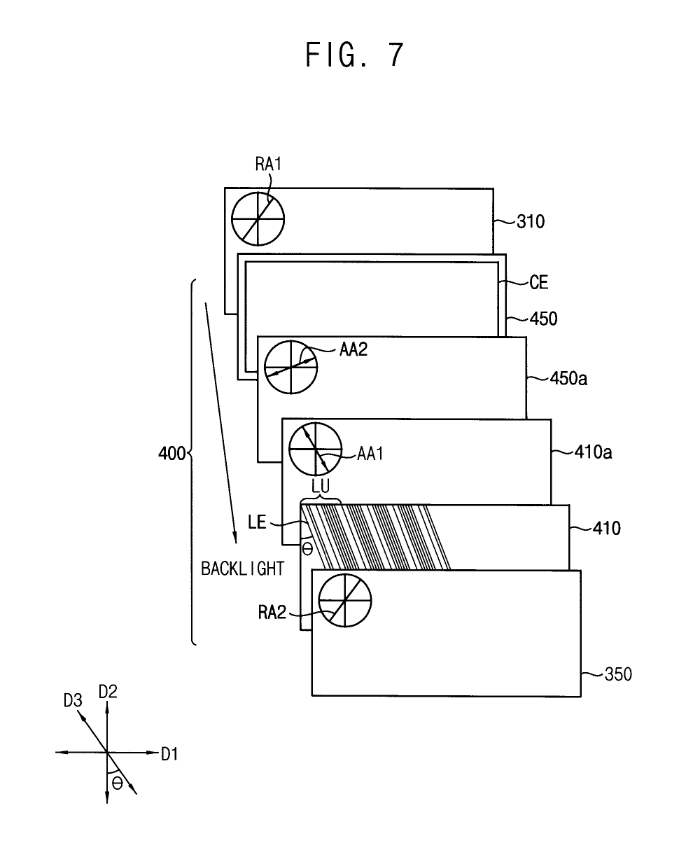

FIG. 7 is an exploded perspective view illustrating another exemplary embodiment of a lens panel assembly according to the invention.

Referring to FIG. 7, a lens panel assembly is substantially the same as the lens panel assembly illustrated in FIG. 2 except that dispositions of the array substrate 410 and the opposing substrate 450 are changed. Thus, the identical elements are briefly described.

Referring to FIG. 7, the lens panel assembly may include a liquid crystal lens panel 400, a first retardation film 310, a second retardation film 350 and an active driving part.

The liquid crystal lens panel 400 may include an array substrate 410, an opposing substrate 450 and a second liquid crystal layer 430.

The opposing substrate 450 may include a lens common electrode CE and a second alignment layer 450a having a second alignment direction AA2. The lens common electrode CE may have a flat-plane shape without a slit pattern defined therein.

The array substrate 410 may face the opposing substrate 450. The array substrate 410 may include a plurality of lens electrode LE and a first alignment layer 410a which has a first alignment direction AA1. The first alignment direction AA1 may be tilted to a desired direction from the second alignment direction AA2. The lens electrodes LE may be grouped to form a plurality of electrode groups LU corresponding to a plurality of liquid crystal lens units. Each of the electrode groups LU may include a desired number of lens electrodes LE. The lens electrodes LE may extend in a third direction D3. The axis of lenses exhibited by the lens electrodes LE may have an inclination angle θ from a second direction D2.

The second liquid crystal layer 430 may be disposed between the array substrate 410 and the opposing substrate 450. Liquid crystal molecules of the liquid crystal layer may be aligned exhibiting a twist angle from the first alignment direction AA1 and the second alignment direction AA2.

The first retardation film 310 may be disposed between the liquid crystal lens panel 400 and a liquid crystal display panel. The first retardation film 310 may delay a phase of light transmitted from the liquid crystal display panel by a first slow axis RA1.

The second retardation film 350 may be adjacent to the array substrate 410 of the liquid crystal lens panel 400. The second retardation film 350 may delay a phase of light transmitted from the liquid crystal lens panel 400 by a second slow axis RA2 which is parallel with the first slow axis RA1.

The active driving part may be configured to provide the liquid crystal lens panel 400 with voltages. The active driving part 330 may apply voltages having a plurality of levels to the lens electrodes LE, thereby implementing liquid crystal lenses. The electrode groups LU may be configured to define the liquid crystal lens units to form the liquid crystal lenses.

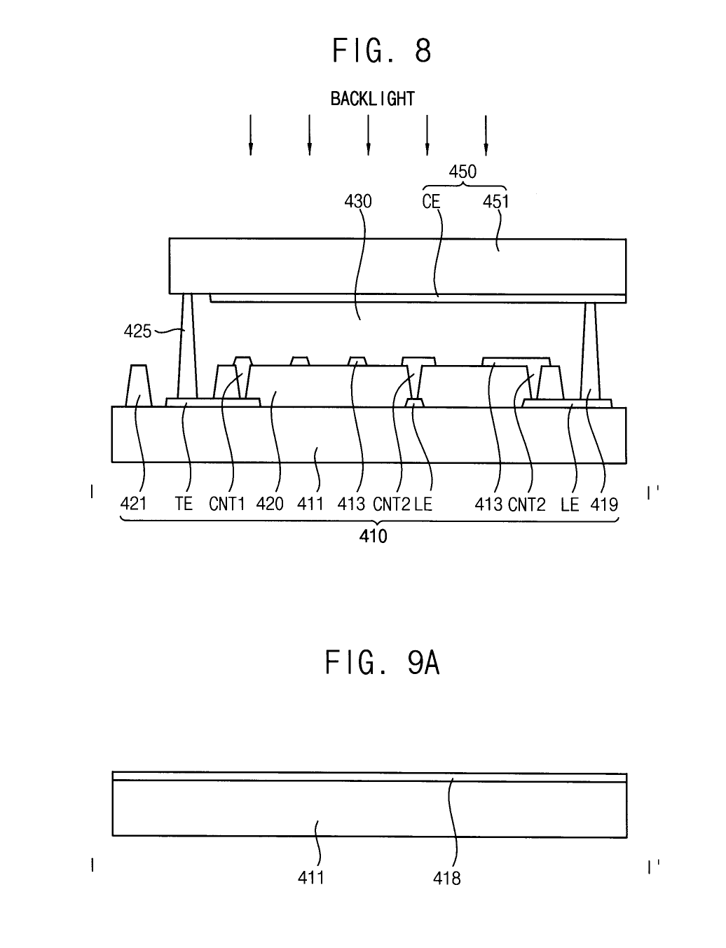

FIG. 8 is a cross-sectional view illustrating a liquid crystal lens panel of the lens panel assembly of FIG. 7.

Referring to FIG. 8, a liquid crystal lens panel is substantially the same as the liquid crystal lens panel illustrated in FIG. 5 except the dispositions of the terminal electrodes TE, the lens electrodes LE and the connection electrodes 413. Thus, the identical elements are briefly described.

Referring to FIG. 8, the liquid crystal lens panel an array substrate 410, an opposing substrate 450 and a second liquid crystal layer 430 therebetween. The liquid crystal layer 430 may be sealed by a seal line 425.

The array substrate 410 may include a first base substrate 411, a plurality of connection electrodes 413, a plurality of lens electrodes LE, a plurality of terminal electrodes TE and a light blocking pattern 420. The array substrate 410 may further include a plurality of column spacers 419. The column spacers 419 may maintain a cell gap between the array substrate 410 and the opposing substrate 450. The array substrate 410 may further include a first alignment layer 410a covering the connection electrodes 413.

The first base substrate 411 may include a transparent insulation material.

The terminal electrodes TE may be disposed on the first base substrate 411. The terminal electrodes TE may extend in a second direction D2 respectively. The terminal electrodes TE may be arranged in a first direction D1 crossing the first direction D2. A first end portion of each of the terminal electrodes TE may be disposed at a peripheral area. A second end portion of each of the terminal electrodes TE opposite to the first end portion may be disposed at a display area. The terminal electrodes TE may include a transparent conductive material. In an exemplary embodiment, for example, the terminal electrodes TE may include IZO, ITO, etc.

The lens electrodes LE may be disposed on the first base substrate 411. The lens electrodes LE may be disposed in and/or on a same layer as the terminal electrodes TE. The lens electrodes LE may extend in a third direction D3 tilted to an angle θ from the second direction D2. The lens electrodes LE may be arranged in a first direction D1 which crosses the second direction D2. The lens electrodes LE may be spaced apart from one another by a desired interval in the first direction D1. The interval between the lens electrodes LE may be different from one another. In an exemplary embodiment, for example, the lens electrodes LE may be spaced apart from one another to form a Fresnel lens having a desired distribution of refraction by a first electrode group LU. The lens electrodes LE may include a transparent conductive material. In an exemplary embodiment, for example, the lens electrodes LE may include IZO, ITO, etc.

The light blocking pattern 420 may be disposed on the first base substrate 411 and the terminal electrodes TE and the lens electrodes LE. The light blocking pattern 420 may partially cover the terminal electrodes TE and the lens electrodes LE. The light blocking pattern 420 may extend in the first direction D1. The light blocking pattern 420 may include an organic and/or inorganic material which absorbs light. In an exemplary embodiment, for example, the light blocking pattern 420 may include CB, TiBK, chromium (Cr), chromium oxide, chromium nitride, etc.

The light blocking pattern 420 may further include at least one or more align mark portion 421 disposed at the peripheral area. The align mark portion 421 may at least partially extend in the second direction D2. Positions of the terminal electrodes TE may be easily recognized due to the align mark portion. Referring to FIG. 4, for example, the light blocking pattern 420 may include a pair of align mark portions 421 respectively adjacent to opposing sides of the terminal part including the terminal electrodes TE.

The connection electrodes 413 may be disposed on the first base substrate 411 and the light blocking pattern 420. The connection electrodes 413 may extend in the first direction D1. The connection electrodes 413 may be arranged in the second direction D2. The connection electrodes 413 may include a metallic material which reflects light. In an exemplary embodiment, for example, the connection electrodes 413 may include aluminum (Al), titanium (Ti), copper (Cu), molybdenum (Mo), tantalum (Ta), tungsten (W), neodymium (Nd), chromium (Cr), silver (Ag), etc.

Each of the connection electrodes 413 may be electrically connected to one of the terminal electrodes TE through a first contact hole CNT1 defined in the light blocking pattern 420. Referring to FIG. 4, for example, a first end portion of each of the connection electrodes 413 may contact with an end portion of one of the terminal electrodes TE through the first contact hole CNT1.

Also, each of the connection electrodes 413 may be electrically connected to one of the lens electrodes LE through a second contact hole CNT2 defined in the light blocking pattern 420. Referring to FIG. 4, for example, a second end portion of the connection electrodes 413 may contact with an end portion of one of the lens electrodes LE through the second contact hole CNT2.

As mentioned above, the connection electrodes 413 may be disposed on the light blocking pattern 420, thereby reducing reflection of external light due to the connection electrodes 413 at the border region of the display area. With reference to the traveling direction of the backlight (indicated by down arrows in FIG. 8), the light blocking pattern 420 follows the connecting electrodes 413, such that the light blocking pattern 420 is between the connection electrodes 413 and the base substrate 411.

The column spacers 419 may be disposed on the first base substrate 411 and the connection electrodes 413. The column spacers 419 may be spaced apart from one another in the display area. As in the illustrated exemplary embodiment, for example, one of the column spacers 419 may be disposed overlapping the lens electrodes LE. The column spacers 419 may include the same material as the light blocking pattern 420.

The opposing substrate 450 may include a second base substrate 451 and a lens common electrode CE. The opposing substrate 450 may further include a second alignment layer 450a (illustrated in FIG. 7) which covers the lens common electrode CE.

The second base substrate 451 may include a transparent insulation material.

The lens common electrode CE may be disposed on the second base substrate 451. The lens common electrode CE may have a flat-plate shape without a slit pattern defined therein. The lens common electrode CE may include a transparent conductive material.

The seal line 425 may be disposed on the array substrate 410 or the opposing substrate 450. Referring to FIG. 4, for example, the seal line 425 may extend in a direction at least partially crossing the terminal electrodes TE on the array substrate 410.

As mentioned above, according to one or more exemplary embodiment of the liquid crystal lens panel and the display device having the same, the connection electrodes 413 may be disposed on the light blocking pattern 420 of the array substrate 410, thereby reducing reflection of external light due to the connection electrodes 413 at the border region of the display area.

Also, the light blocking pattern 420 may further include the align mark portion which extends toward an outside of the display area to clearly indicate a position of the terminal electrodes TE, thereby allowing relatively easy connection of the terminal electrodes TE to an external power source (not shown).

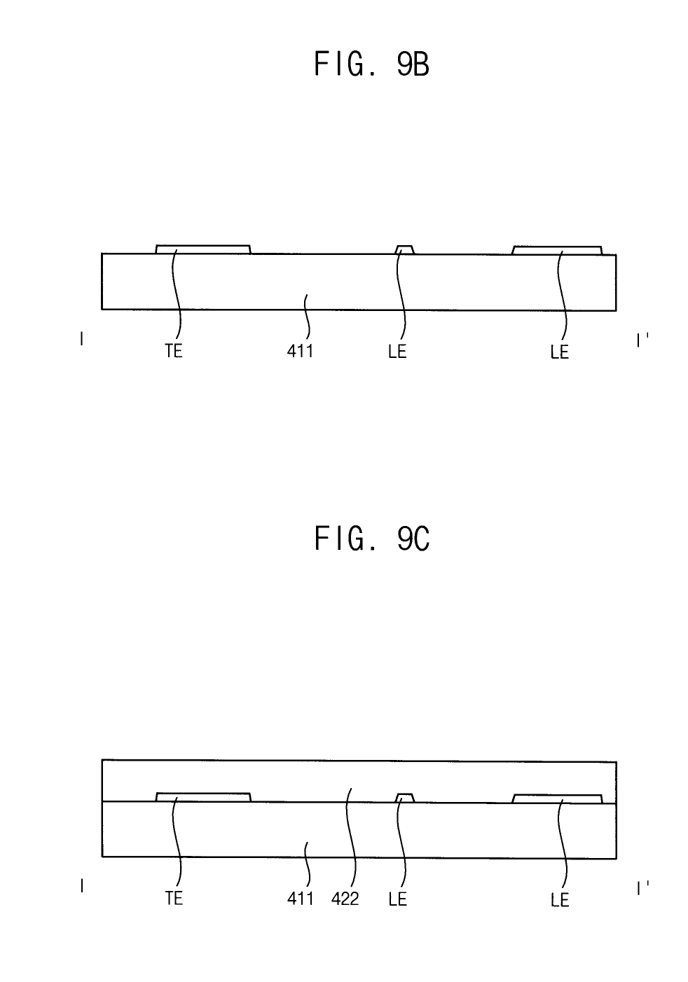

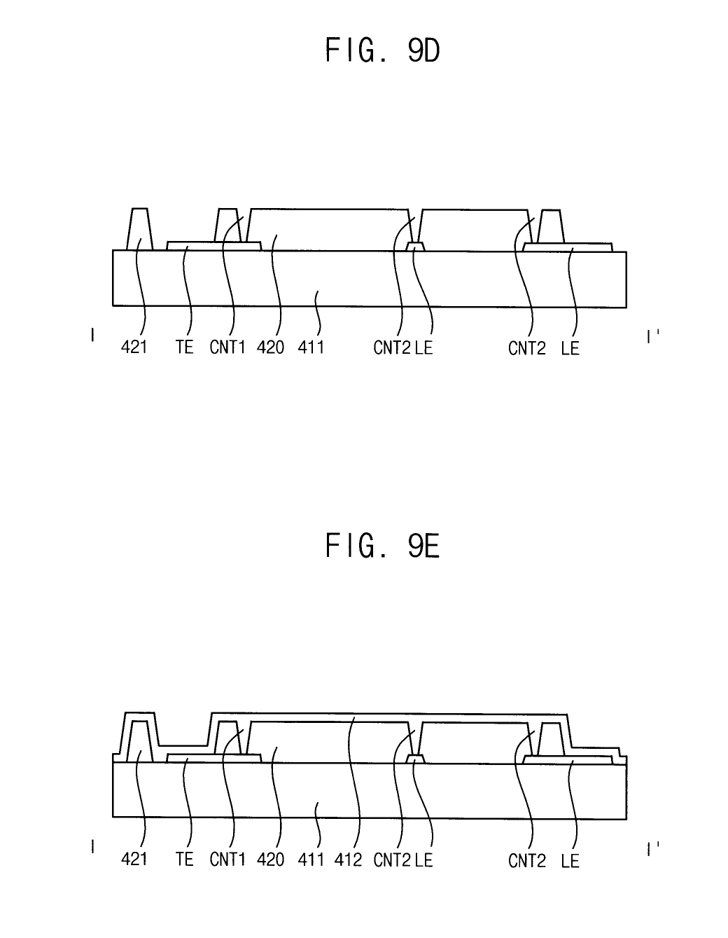

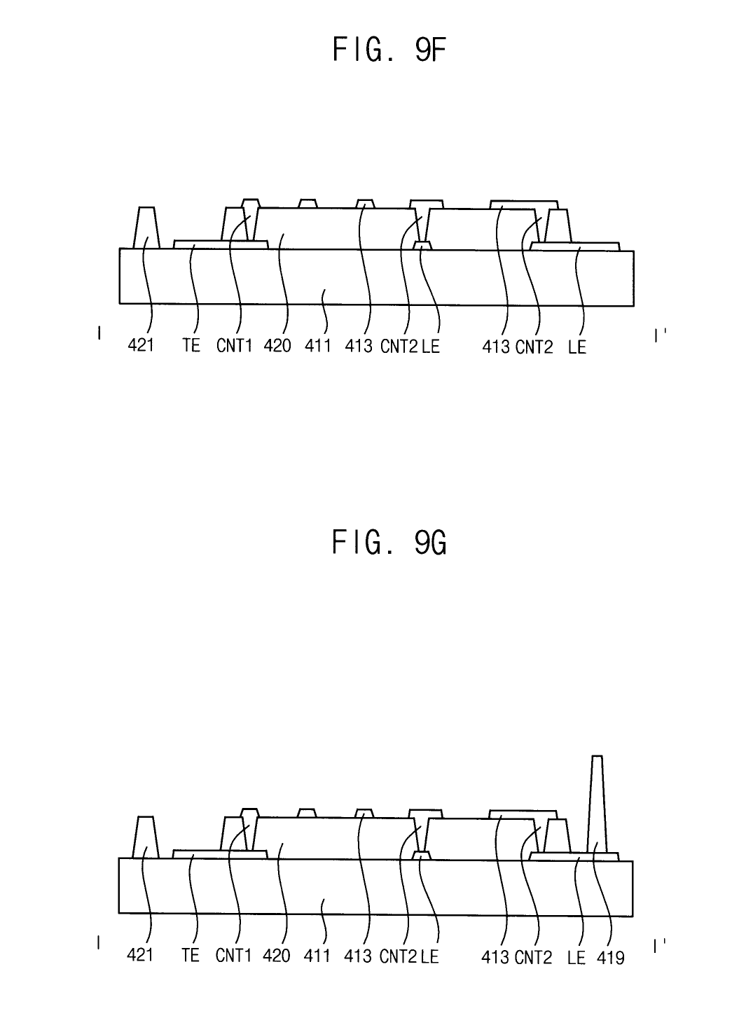

FIGS. 9A to 9G are cross-sectional views illustrating an exemplary embodiment of a manufacturing method of an array substrate of the liquid crystal lens panel of FIG. 8.

Referring to FIG. 9A, a transparent conductive layer 418 may be formed on a first base substrate 411. The transparent conductive layer 418 may include, for example, IZO, ITO, etc.

Referring to FIG. 9B, the transparent conductive layer 418 may be patterned such as by using a first mask to form a plurality of terminal electrodes TE and a plurality of lens electrodes LE on the first base substrate 411. The terminal electrodes TE may extend in a second direction D2 respectively. The terminal electrodes TE may be arranged in a first direction D1 which crosses the second direction D2. The lens electrodes LE may extend in a third direction D3 tilted to an angle θ from the second direction D2 respectively. The lens electrodes LE may be arranged in the first direction D1. Intervals between the lens electrodes LE may be different from one another in the first direction D1.

Referring to FIG. 9C, a light blocking layer 422 may be formed on the first base substrate 411 including the terminal electrodes TE and the lens electrodes LE thereon. The light blocking layer 422 may entirely cover the terminal electrodes TE and the lens electrodes LE. The light blocking layer 422 may include an organic and/or inorganic material which absorbs light. In an exemplary embodiment, for example, the light blocking layer 422 may include CB, TiBK, chromium (Cr), chromium oxide, chromium nitride, etc.

Referring to FIG. 9D, the light blocking layer 422 may be patterned such as by using a second mask to form a light blocking pattern 420 on the first base substrate 411. The light blocking pattern 420 may extend in the first direction D1. The light blocking pattern may partially cover the terminal electrodes TE and the lens electrodes LE. The light blocking pattern 420 may further include an align mark portion 421 disposed at the peripheral area. A first contact hole CNT1 and a second contact hole CNT2 each exposing a portion of the terminal electrodes TE and the lens electrodes LE may be defined in the light blocking pattern 420.

Referring to FIG. 9E, a connection electrode layer 412 may be formed on the first base substrate 411 including the light blocking pattern 420 thereon. The connection electrode layer 412 may include a metallic material which reflects light. In an exemplary embodiment, for example, the connection electrode layer 412 may include aluminum (Al), titanium (Ti), copper (Cu), molybdenum (Mo), tantalum (Ta), tungsten (W), neodymium (Nd), chromium (Cr), silver (Ag), etc.

Referring to FIG. 9F, the connection electrode layer 412 may be patterned such as by using a third mask to form a plurality of connection electrodes 413 on the first base substrate 411 and extending into the first and second contact holes CNT1 and CNT2. The connection electrodes 413 may extend in the first direction D1. The connection electrodes 413 may be arranged in the second direction D2. Each of the connection electrodes 413 may be electrically connected to one of the terminal electrodes TE through the first contact hole CNT1. Also, each of the connection electrodes 413 may be electrically connected to one of the lens electrodes LE through the second contact hole CNT2.

Referring to FIG. 9G, an insulation layer may be formed on the first base substrate 411. The insulation layer may be patterned such as by using a fourth mask to form a plurality of column spacers 419. The column spacers 419 may be spaced apart from one another in the display area. As in the illustrated exemplary embodiment, for example, one of the column spacers 419 may be disposed on the lens electrodes LE.

According to one or more exemplary embodiment of the liquid crystal lens panel, the display device having the same and the method of manufacturing the same, the light blocking pattern may cover the connection electrodes, thereby reducing reflection of external light which is able to be recognized at a border region of a display area of the liquid crystal lens panel.

Also, in one or more exemplary embodiment of the method of manufacturing the liquid crystal lens panel, the light blocking pattern may be directly formed on the array substrate including the connection electrodes thereon, thereby reducing manufacturing cost of the liquid crystal lens panel without an additional mask to form the light blocking pattern on the opposing substrate.

Furthermore, in one or more exemplary embodiment of the liquid crystal lens panel, the light blocking pattern may further include an align mark portion which extends to an outside of the display area to clearly indicate a position of terminal electrodes, thereby allowing relative easy connection of an external terminal power source to the terminal electrodes which are connected to the connection electrodes.

The foregoing is illustrative of the invention and is not to be construed as limiting thereof Although a few exemplary embodiments have been described, those skilled in the art will readily appreciate that many modifications are possible in exemplary embodiments without materially departing from the novel teachings and advantages of the invention. Accordingly, all such modifications are intended to be included within the scope of the exemplary embodiments as defined in the claims. In the claims, means-plus-function clauses are intended to cover the structures described herein as performing the recited function and not only structural equivalents but also equivalent structures. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A liquid crystal lens panel comprising:
an array substrate comprising:
a first base substrate;
a plurality of lens electrodes substantially parallel with one another, on the first base substrate;
a connection electrode electrically connected to the lens electrodes;
a light blocking pattern overlapping the connection electrode; and
a terminal electrode electrically connected to the connection electrode;
an opposing substrate comprising:
a second base substrate which faces the array substrate, and
a lens common electrode on the second base substrate; and
a liquid crystal layer between the array substrate and the opposing substrate.

2. The liquid crystal lens panel of claim 1, wherein the lens electrodes and the terminal electrode are in a same layer.

3. The liquid crystal lens panel of claim 1, wherein the connection electrode is between the light blocking pattern and the first base substrate.

4. The liquid crystal lens panel of claim 3, further comprising contact holes defined in the light blocking pattern,
wherein
the light blocking pattern is between the lens electrodes and the connection electrode and between the terminal electrode and the connection electrode, and
the lens electrodes and the terminal electrode are electrically connected to the connection electrode through the contact holes defined in the light blocking pattern.

5. The liquid crystal lens panel of claim 1, wherein the lens electrodes and the terminal electrode, are between the light blocking pattern and the first base substrate.

6. The liquid crystal lens panel of claim 5, further comprising contact holes defined in the light blocking pattern,
wherein
the light blocking pattern is between the connection electrode and the lens electrodes and between the connection electrode and the terminal electrode, and
the connection electrode is electrically connected to the lens electrodes and the terminal electrode, through the contact holes defined in the light blocking pattern.

7. The liquid crystal lens panel of claim 1, further comprising a column spacer partially overlapping a lens electrode among the plurality of lens electrodes.

8. The liquid crystal lens panel of claim 1, wherein the light blocking pattern extends in a first direction in which the connection electrode extends.

9. The liquid crystal lens panel of claim 8, further comprising a sealing member which crosses the terminal electrode, and maintains a cell gap between the array substrate and the opposing substrate.

10. The liquid crystal lens panel of claim 9, wherein the light blocking pattern comprises an align mark portion adjacent to the terminal electrode, and the align mark portion comprises:
a first extending portion crossing the first direction and extending in a second direction in which the terminal electrode extends toward an outside of the sealing member and
a second extending portion extending from a distal end of the first extending portion and in a third direction crossing the second direction.

11. A display device comprising:
a liquid crystal lens panel;
a liquid crystal display panel configured to emit multi-viewpoint images toward the liquid crystal lens panel, by using a plurality of pixel electrodes and a pixel common electrode; and
a light source part configured to generate and emit light toward the liquid crystal display panel,
wherein the liquid crystal lens panel comprises:
an array substrate comprising:
a plurality of lens electrodes substantially parallel with one another;
a connection electrode electrically connected to the lens electrodes;
a light blocking pattern overlapping the connection electrode; and
a terminal electrode electrically connected to the connection electrode;
an opposing substrate facing the array substrate and comprising a lens common electrode; and
a liquid crystal layer between the array substrate and the opposing substrate.

12. The display device of claim 11 further comprising a retardation film between the liquid crystal lens panel and the liquid crystal display panel.

13. The display device of claim 11 further comprising an active driving part configured to drive the liquid crystal lens panel,
wherein the active driving part is configured to apply voltages to the lens electrodes and the lens common electrode to form a plurality of liquid crystal lens units.

14. The display device of claim 13, wherein the liquid crystal lens units are configured to refract the multi-viewpoint images emitted by liquid crystal display panel, toward a plurality of viewpoint areas with respect to the display device.

15. The display device of claim 11, wherein the lens electrodes and the terminal electrode are in a same layer, and comprise a transparent conductive material.

16. The display device of claim 11, wherein the array substrate further comprises a first base substrate and contact holes defined in the light blocking pattern, and
wherein
the connection electrode is between the light blocking pattern and the first base substrate,
the light blocking pattern is between the lens electrodes and the connection electrode and between the terminal electrode and the connection electrode, and
the lens electrodes and the terminal electrode are electrically connected to the connection electrode through the contact holes defined in the light blocking pattern.

17. The display device of claim 11, wherein the array substrate further comprises a first base substrate and contact holes defined in the light blocking pattern, and
wherein
the lens electrodes and the terminal electrode, are between the light blocking pattern and the first base substrate,
the light blocking pattern is between the connection electrode and the lens electrodes and between the connection electrode and the terminal electrode, and
the connection electrode is electrically connected to the lens electrodes and the terminal electrode, through the contact holes defined in the light blocking pattern.

18. A method of manufacturing a liquid crystal lens panel comprising:
forming a light blocking metal layer on a base substrate;
patterning the light blocking metal layer to form a connection electrode;
forming a light blocking layer covering the connection electrode on the base substrate;
patterning the light blocking layer to form a plurality of contact holes partially exposing the connection electrode;
forming a transparent conductive layer on the base substrate and in the contact holes; and
patterning the transparent conductive layer to form a plurality of lens electrodes substantially parallel with one another, and a terminal electrode,
wherein
the terminal electrode is electrically connected to the connection electrode through a first contact hole among the plurality of contact holes, and
the lens electrodes are electrically connected to the connection electrode through second contact holes among the plurality of contact holes and being.

19. The method of claim 18 further comprising:
forming a plurality of column spacers on the lens electrodes and spaced apart from one another.

20. A method of manufacturing a liquid crystal lens panel comprising:
forming a transparent conductive layer on a base substrate;
patterning the transparent conductive layer to form a plurality of lens electrodes substantially parallel with one another, and a terminal electrode;
forming a light blocking layer covering the terminal electrode and the lens electrodes on the base substrate;
patterning the light blocking layer to form a plurality of contact holes partially exposing the terminal electrode and the lens electrodes;
forming a light blocking metal layer on the base substrate and in the contact holes; and
patterning the light blocking metal layer to form a connection electrode,
wherein the connection electrode is electrically connected to the terminal electrode through a first contact hole among the plurality of contact holes and is electrically connected to the lens electrodes through second contact holes among the plurality of contact holes.
